(19) United States
(12) Patent Application Publication
(10) Pub. No.: US 2022/0240548 A1
(43) Pub. Date: Aug. 4, 2022

(54) NON-ALCOHOLIC BEERLIKE BEVERAGE

(71) Applicant: Suntory Holdings Limited, Osaka-shi, Osaka (JP)

(72) Inventors: Yohei Fujita, Takatsuki-shi, Osaka (JP); Yuichi Kato, Kokubunji-shi, Tokyo (JP)

(73) Assignee: Suntory Holdings Limited, Osaka-shi, Osaka (JP)

(21) Appl. No.: 17/611,627

(22) PCT Filed: May 28, 2020
(86) PCT No.: PCT/JP2020/021117

§ 371 Date: Nov. 16, 2021

(30) Foreign Application Priority Data
May 31, 2019 (JP) 2019-102820

(51) Int. Cl. A23L 2/52

(52) U.S. Cl. CPC A23L 2/52; A23V 2002/00

(57) ABSTRACT

A nonalcoholic beer-taste beverage wherein the content of glutamic acid is from 27 to 90 ppm, the content of succinic acid is 24 ppm or less, the content of alanine is 32 ppm or less, and the content of glycine is 24 ppm or less.

According to the present invention, a beer-taste beverage with a new taste having an excellently rich taste can be provided.

### TECHNICAL FIELD

The present invention relates to a nonalcoholic beer-taste beverage and a method for producing the same, and a method of giving a rich taste to a nonalcoholic beer-taste beverage.

### BACKGROUND ART

With the diversification of the inclinations of the consumers in the recent years, the development of nonalcoholic beer-taste beverages having various flavor characteristics has been desired. For example, Patent Publication 1 discloses that the acidic taste in a beer-taste malt beverage can be reduced or moderated with a pH adjusting agent by a combination of specific amino acid concentrations. In addition, Patent Publication 2 discloses the use of an extract of a treated product as a flavor improving agent, the extract being obtained by seeding an yeast to hops and subjecting the hops to a fermentation treatment, in order to give a nonalcoholic beer-taste beverage or the like a natural, mild, and robust beer-likeness in the same manner as beers, or the like.

### RELATED ART REFERENCES

### PATENT PUBLICATIONS

Patent Publication 1: Japanese Patent Gazette No. 5231438
Patent Publication 2: Japanese Patent Laid-Open No. 2014-82976

### SUMMARY OF THE INVENTION

### Problems to be Solved by the Invention

However, Patent Publication 1 does not disclose a technique of giving a rich taste by adjusting an amino acid concentration, and when a flavor improving agent as in Patent Publication 2 is used, there are some cases where the quality of the flavors of the beverages might be undesirably influenced. Therefore, further improvements are desired for giving a rich taste to nonalcoholic beer-taste beverages.

The present invention relates to the provision of a nonalcoholic beer-taste beverage having an excellently rich taste and a method for producing the same, and a method of giving a rich taste to a nonalcoholic beer-taste beverage.

### Means to Solve the Problems

The present invention relates to the followings [1] to [3]:
[1] A nonalcoholic beer-taste beverage wherein the content of glutamic acid is from 27 to 90 ppm, the content of succinic acid is 24 ppm or less, the content of alanine is 32 ppm or less, and the content of glycine is 24 ppm or less.
[2] A method for producing a nonalcoholic beer-taste beverage as defined in [1], including adding glutamic acid and/or a salt thereof.
[3] A method of giving a rich taste to a nonalcoholic beer-taste beverage including adding glutamic acid and/or a salt thereof.

### Effects of the Invention

According to the present invention, a nonalcoholic beer-taste beverage having an excellently rich taste and a method for producing the same, and a method for giving a rich taste to a nonalcoholic beer-taste beverage can be provided.

### Modes for Carrying out the Invention

In the nonalcoholic beer-taste beverage, the content of glutamic acid is usually from 0 to 2 ppm or so. In addition, glutamic acid has been known as umami (tastiness) ingredient, and a threshold value as the umami ingredient is set at 300 ppm. As a result of intensively studying the above problems, the inventors of the present mvention have newly surprisingly found that a nonalcoholic beer-taste beverage having an excellently rich taste is obtained when glutamic acid is added in a trace amount to have a given concentration at a level that would not be purposed for giving umami.

The nonalcoholic beer-taste beverage of the present invention contains glutamic acid. The content of glutamic acid of the nonalcoholic beer-taste beverage of the present invention is 27 ppm or more, preferably 30 ppm or more, and more preferably 35 ppm or more, from the viewpoint of strengthening the rich taste, and the content is 90 ppm or less. preferably 70 ppm or less, and more preferably 47 ppm or less, from the same viewpoint, and the content may be within the range of any of the combinations given above. As to the contents of the amino acids other than glutamic acid or the organic acid in the nonalcoholic beer-taste beverage of the present invention, from the viewpoint of strengthening the rich taste, the content of succinic acid is 24 ppm or less, preferably 20 ppm or less, and more preferably 15 ppm or less, the content of alanine is 32 ppm or less, preferably 25 ppm or less, and more preferably 20 ppm or less, and the content of glycine is 24 ppm or less, and preferably 20 ppm or less. A total content of succinic acid, alanine, and glycine is preferably 60 ppm or less, more preferably 50 ppm or less, and even more preferably 40 ppm or less, from the viewpoint of reducing a disagreeable taste. Each of the lower limits for succinic acid, alanine, and glycine and a total content of these acids are not particularly limited, and the contents can he independently, for example, 0 ppm or more, 0.5 ppm or more, 1 ppm or more, 1.5 ppm or more, 2.0 ppm or more, 3.0 ppm or more, 5.0 ppm or more, and the like. As to the upper and lower limits thereof, the content may be within the range of any of the combinations given above. The contents of the amino acids as used herein are measured by amino acid analyzer, and the content of the organic acid as used herein is measured by high-performance liquid chromatography (HPLC) method.

The method for producing a nonalcoholic beer-taste beverage of the present invention is not particularly limited, and the method for production is exemplified by a method for producing a nonalcoholic beer-taste beverage including adding glutamic acid and/or a salt thereof. In the present production embodiment, the nonalcoholic beer-taste beverage can be produced in the same manner as any one of general nonalcoholic beer-taste beverages except that glutamic acid and/or a salt thereof is added. The salts of glutamic acid include well-known salts that are acceptable in foods, and, for example, alkali metal salts such as sodium salts and potassium salts and alkaline earth metal salts such as calcium salts and magnesium salts can be used. Although the commercially available preparation containing glutamic acid and/or a salt thereof is not particularly limited, the commercially available preparation includes, for example, a mixed composition with a seasoning preparation such as nucleic acid, and the like. In addition, the commercially available preparation contains raw materials for general foods themselves and seasonings, and the like, and, for example, seasoning preparations such as protein degradation products of various animals or plants or an yeast extract, and the like can be used. Here, in order to have the content of each of succinic acid, alanine, and glycine equal to or lower than a given content, the amounts used and the like may be adjusted regardless of whether the raw materials without containing these components are used or the raw materials containing these components are used. In particular, succinic acid can he added as an acidulent within the range that would not exceed the given content. General production steps for a nonalcoholic beer-taste beverage will be shown hereinbelow. A nonalcoholic general beer-taste beverage is one in which malts are used or not used as raw materials, which can be produced in the following manner.

As to the nonalcoholic beer-taste beverage produced by using malts as raw materials, first, to a mixture containing raw materials such as wheat. such as malts, optionally other grains, starches, sugars, a bittering agent, or a colorant, and water is added an enzyme such as amylase optionally to carry out gelatinization or saccharification, and the mixture is then filtered, to provide a saccharified liquid. Hops, a hittering agent or the like is optionally added to the saccharified liquid, and a mixture is boiled, to remove solid contents such as coagulated proteins in a clearing tank. As a substitute for this saccharified liquid, hops may be added to a hot water added with a malt extract, and a mixture may be boiled. The hops may be mixed at any stage from the beginning of boiling to before the termination of boiling. As the conditions in the saccharification step, the boiling step, the solid content removal step, and the like, known conditions may be used. After boiling. the wort obtained is filtered, and a carbon dioxide gas is added to a filtrate obtained. Thereafter, a vessel is filled, and subjected to a sterilizing step, to obtain an intended nonalcoholic beer-taste beverage. In each of the above steps, glutamic acid and/or a salt thereof may be added in any steps up to filling. Glutamic acid and/or a salt thereof can be added before the boiling step of wort, from the viewpoint of microbial quality guarantee, and glutamic acid and/or a salt thereof may be added immediately before filling the container, from the viewpoint of the component migration rate.

In the case of producing a nonalcoholic beer-taste beverage without using malts as raw materials, first, a liquid sugar containing a carbon source, a nitrogen source as an amino acid-containing material other than wheat or malts, hops, a pigment, and the like are mixed together with a hot water, to provide a liquid, sugar-containing solution. The liquid sugar-containing solution is boiled. When hops are used as raw materials, the hops may be mixed with the liquid sugar-containing solution during boiling, not before the beginning of boiling. A carbon dioxide gas is added to the liquid sugar-containing solution after boiling. Thereafter, a vessel is filled, and subjected to a sterilizing step, to obtain an intended nonalcoholic beer-taste beverage. In each of the above steps, glutamic acid and/or a salt thereof may be added in any steps up to filling. Glutamic acid and/or a salt thereof care be added before the boiling step of wort, from the viewpoint of microbial quality guarantee, and glutamic acid and/or a salt thereof may be added immediately before filling the container, from the viewpoint of the component migration rate.

The term “beer-taste beverage” as used herein refers to a carbonated beverage having a beer-like flavor. Among them, the term “nonalcoholic beer-taste beverage” refers to a beer-taste beverage having an alcoholicity of less than 1%, preferably 0.005% or less, and more preferably does not substantially contain an alcohol. Here, the beverage of the embodiment that substantially does not contain an alcohol does not intend to exclude a beverage containing a very small amount of alcohol to an extent that is undetectable. A beverage of which alcoholicity would be rounded off to 0.0%, and especially a beverage of which alcoholicity is rounded off to 0.00%, is embraced in the nonalcoholic beer-taste beverage. The kinds of the nonalcoholic beer-taste beverage of the present invention include, for example, nonalcoholic beer-taste beverages, beer-taste refreshing beverages, and the like. Here, the term “alcoholicity (alcohol content)” as used herein means the content of ethanol, but an aliphatic alcohol is not included therein.

The alcoholicity of the nonalcoholic beer-taste beverage according to the present invention means a content (v/v %) of an alcoholic content of the beverage, and the alcoholicity can be measured by any of known methods. For example, the alcoholicity can be measured with an oscillating densitometer. Specifically, a sample in which a carbon dioxide gas is degassed from a beverage by filtration or ultrasonication is prepared, and the sample is distilled with direct flame, and a density of the distillated solution obtained is measured at 15° C., and the alcoholicity can be converted and obtained from “Table 2 Alcoholic Content and Density (1.5° C.) and Specific Gravity (15/15° C.) Conversion Table” which is an annex to internal Revenue Bureau, Specified Analysis Method (2007 Internal Revenue Bureau Order No. 6, revised Jun. 22, 2007). In a case of a low concentration with an alcoholicity of less than 1.0%, a commercially available alcohol measurement instrument or gas chromatography may be used.

in the method for production of the present invention, an aliphatic alcohol may be added to the nonalcoholic beer-taste beverage according to the present invention, from the viewpoint of giving a liquor-taste. The aliphatic alcohol is not particularly limited so long as it is a known one, and an aliphatic alcohol having 4 to 5 carbon atoms is preferred. In the present invention, preferred aliphatic alcohols include aliphatic alcohols having 4 carbon atoms such as 2-methyl-1-propanol and 1-butanol; and aliphatic alcohols having 5 carbon atoms such as 3-methyl-1-butanol, 1-pentanol, and 2-pentanol. These aliphatic alcohols can be used alone or in a combination of two or more kinds. The content of the aliphatic alcohol having 4 to 5 carbon atoms is preferably from 0.0002 to 0.0007% by mass, and more preferably from 0.0003 to 0.0006% by mass. In the present specification, the content of the aliphatic alcohol can be measured by using a headspace gas chromatography.

(Calories)

Among the nonalcoholic beer-taste beverages according to the present invention, it is desired that the nonalcoholic beer-taste beverage is low in calories, matching in the favor of low-calorie diets in the recent years. Therefore, the nonalcoholic beer-taste beverage according to the present invention has the number of calories of preferably less than 5 kcal/100 mL, more preferably less than 4 kcal/100 mL, and even more preferably less than 3 kcal/100 mL.

The number of calories included in the nonalcoholic beer-taste beverage according to the present invention is basically calculated in accordance with “Method and the like for Analyzing Nutrient Ingredients etc. in Nutritional Labelling Standards” published in association with the Health Promotion Act. In other words, in principle, the number of calories can be calculated as a total sum of the amount of the various nutrient ingredients quantified multiplied by an energy conversion coefficient of each ingredient (protein: 4 kcal/g, fat: 9 kcal/g, saccharine: 4 kcal/g, dietary fibers: 2 kcal/g, alcohol: 7 kcal/g, or organic acid: 3 kcal/g). For details, see “Method and the like for Analyzing Nutrient ingredients etc. in Nutritional Labelling Standards.”

Specific measurement methods for the amounts of each of nutrient ingredients contained in the nonalcoholic beer-taste beverage according to the present invention may be carried out in accordance with various methods of analyses described in the Health Promotion Act. “Method and the like for Analyzing Nutrient Ingredients etc. in Nutritional Labelling Standards.” Alternatively, if requested to Incorporated Foundation, Japan Food Research Laboratories, one can know the calories and/or each of amounts of nutrient ingredients.

(Saccharides)

The saccharides contained in the nonalcoholic beer-taste beverage according to the present invention refer to saccharides based on the Nutritional Labelling Standards for Foods (2003 Ministry of Health, Labour, and Welfare, Announcement No. 176). Specifically, the saccharides refer to a group of foods from which proteins, fats, dietary fibers, ashes, alcohols, and water are excluded. In addition, the amount of saccharides in the foods is calculated by deduction of the amounts of proteins, fats, dietary fibers, ashes, and water from the weight of the above foods. In this case. the amounts of proteins, fats, dietary fibers, ashes, and water are measured by a method set out in the Nutritional Labelling Standards. Specifically, the amount of proteins is measured by nitrogen quantification conversion method; the amount of fats is measured by an ether extraction method, a chloroform-methanol liquid mixture extraction method, a Gerber method, an acid decomposition method or a Roese-Gottlieb method; the amount of dietary fibers is measured by high-performance liquid chromatography or Prosky method; the amount of ashes is measured by a method of ashing with magnesium acetate, a direct ashing method, or a method of ashing with sulfuric acid; and the amount of water is measured by Karl-Fischer method, a method using a drying aid, a vacuum thermal drying method, an atmospheric thermal drying method, or a plastic film method.

It is desired that the nonalcoholic beer-taste beverage according to the present invention is low in saccharides, matching in the favor of the low carbohydrate diet in the recent year. Therefore, the content of the saccharide of the nonalcoholic beer-taste beverage according to the present invention is preferably less than 0.5 g/100 mL, more preferably 0.4 g/100 mL or less, and even more preferably 0.3 g/100 mL or less. In addition, the lower limit of the content is, but not particularly set, usually 0.1. g/100 mL or so, which may be, for example, 0.15 g/100 mL or more, and 0.2 g/100 mL or more.

(Acidulant)

As the acidulant used in the method for production according to the present invention, it is preferable to use one or more acids selected from the group consisting of citric acid, lactic acid, phosphoric acid, and malic acid. In addition, in the method for production of the present invention, as an acid other than the above acids, succinic acid, tartaric acid, fumaric acid, glacial acetic acid or the like can he used. These acidulants can be used without limitations so long as the acidulants are accepted to be added to foods. In the method for production of the present invention, it is preferable to use a combination of lactic acid from the viewpoint of appropriately giving a moderate sour taste, and phosphoric acid from the viewpoint of appropriately giving an sour taste with a slightly stimulating taste.

The content of the acidulant in the nonalcoholic beer-taste beverage according to the present invention, calculated in terms of citric acid, is preferably 200 ppm or more, more preferably 300 ppm or more, and even more preferably 400 ppm or more, from the viewpoint of providing a beer-like taste, and the content is preferably 15000 ppm or less, more preferably 5500 ppm or less, and even more preferably 2000 ppm or les, from the viewpoint of acidity. As to the upper and lower limits thereof, the content may he within the range of any of the combinations given above. Here, the amount calculated in terms of citric acid as used herein refers to an amount converted from an acidity of each of the acidulants on the basis of the acidity of citric acid. For example, the amount which is equivalent to 100 ppm of lactic acid, calculated in terms of citric acid, is 120 ppm, the amount which is equivalent to 100 ppm of phosphoric acid, calculated in terms of citric acid, is 200 ppm, and the amount which is equivalent to 100 ppm of malic acid, calculated in terms of citric acid, is 125 ppm.

The content of the acidulant in the nonalcoholic beer-taste beverage refers to those calculated by analyzing with high-performance liquid chromatography (HPLC) or the like.

(Hops)

In the method for production of the present invention, hops can he used as a part of the raw materials. Since the flavor tends to resemble beer, it is desired that hops are used in a part of the raw materials. When hops are used, usual pellet hops, powder hops or a hop extract used in the production of beer and the like can be appropriately selected and used in accordance with a desired flavor. In addition, hop working products such as isomerized hops and reduced hops may be used. The hops used in the nonalcoholic beer-taste bevarage according to the present invention embrace those products. Also, the amount of the hops is, but not particularly limited to, typically from 0.0001 to 1% by weight or so, based on the entire amount of the beverage.

(Other Raw Materials)

In the method for production according to present invention, other raw materials may be optionally used within the range that would not inhibit the effects of the present invention. For example, a sweetener (including a high-intensity sweetener), a bittering agent, a flavor (aromatic), an yeast extract, a colorant such as a caramel pigment, plant extracted saponin-based material such as soybean saponin or quillai saponin, a vegetable protein- and peptide-containing product such as maize or soybeans, an animal protein such as whey, dietary fibers, a seasoning such as amino acids, or an antioxidant such as ascorbic acid can optionally be used within the range that would not inhibit the effects of the present invention.

Thus, a nonalcoholic beer-taste beverage according to the present invention is obtained. The pH of the nonalcoholic beer-taste beverage according to the present invention is from 3.0 to 5.0, preferably from 3.5 to 4.5, and more preferably 3.5 to 4.0, from the viewpoint of making the flavor of the beverage favorable.

(Container-Packed Beverage)

The nonalcoholic beer-taste beverage according to the present invention can be packed into a container. The shapes or the containers are not limited in any manners, and the nonalcoholic beer-taste beverage can be packed into a tightly sealed container such as a glass bottle, a can, a barrel, or a plastic bottle, whereby a beverage contained in a container can be provided.

The present invention also provides a method of giving a rich taste to a nonalcoholic beer-taste beverage including adding glutamic acid and/or a salt thereof. The details of each component and the like in the method for giving a rich taste of the present invention are as explained above.

### EXAMPLES

The present invention will be specifically described hereinbelow by the Examples, without intending to limit the scope of the present invention to the following Examples.

<Preparation of Nonalcoholic Beer-Taste Beverages >

### Examples 1 to 18 and Comparative Examples 1 to 7

To a commercially available nonalcoholic beer-taste beverage (Reference Example 1, manufactured by Suntory Holdings Limited under the trade name of ALL-FREE) were added sodium glutamate (manufactured by MC Food Specialties Incorporated), disodium succinate hexahydrate (manufactured by marugo corporation), alanine (manufactured by Ajinomoto Healthy Supplies Co., Ltd.), and glycine (manufactured by Ajinomoto Healthy Supplies Co., Ltd.), each so as to have a concentration as listed in Tables 1 to 4, to give a nonalcoholic beer-taste beverage. Here, the concentrations as listed in Table 1 are concentrations in terms of glutamic acid or succinic acid calculated from sodium glutamate or disodium succinate hexahydrate.

With respect to the nonalcoholic beer-taste beverages obtained, the relative scoring was carried out by six specialized panelists on the bases of the following evaluation criteria by defining the score of Reference Example 1 as “0,5,” the scoring being made in an increment of 0.25, and a mean score of the scores of the six specialized panelists was calculated. On the basis of this mean score, the extent of the enhanced effects of the rich taste was indicated by symbols × to ⊚, in accordance with the following criteria. When the judgments were Δ or higher, it is found that the rich taste is enhanced. The results are shown in Tables 1 to 5.

### (Scores for Rich Taste)

0: Not tasted at all;
1: Faintly tasted;
2: Distinctively tasted; and
3: Highly Strongly tasted.

### (Evaluation Criteria for Rich Taste)

×: Score for rich taste is less than 1.0;
Δ: Score for rich taste is 1.0 or more and less than 1.5;
◯:Score for rich taste is 1.5 or more and less than 2.0; and
⊚:Score for rich taste is 2.0 or more.

With respect to the nonalcoholic beer-taste beverages shown in Tables 2 to 5, the relative scoring was carried out by six specialized panelists on the bases of the following evaluation criteria. The scoring was made in an increment of 0.25, and a mean score of the scores of the six specialized panelists was calculated. On the basis of this mean score, the extent of the freeness from the disagreeable taste was indicated by symbols × to ⊚, in accordance with the following criteria. When the judgments were Δ or higher, it is acknowledged to be without any problems as beverages. The disagreeable taste refers to a foreign umami stimulation that loses the balance of the overall umami.

### (Scoring of Freeness of Disagreeable Taste)

0: tasted a disagreeable taste;
1: slightly tasted a disagreeable taste;
2: hardly tasted a disagreeable taste; and
3: not tasted a disagreeable taste at all.

### (Evaluation Criteria for Freeness of Disagreeable Taste)

×: Score for freeness of disagreeable taste is less than 1.0:
Δ: Score for freeness of disagreeable taste is 1.0 or more and less than 1.5;
◯: Score for freeness of disagreeable taste is 1.5 or more and less than 2.0; and
⊚: Score for freeness of disagreeable taste is 2.0 or more.

TABLE 1

| | Ref. | Comp. | | | | | Comp. |
|---|---|---|---|---|---|---|---|
| | Ex. 1 | Ex. 1 | Ex. 1 | Ex. 2 | Ex. 3 | Ex. 4 | Ex. 2 |
| Content of | 1.5 | 23 | 28 | 32 | 45 | 89 | 132 |
| glutamic acid, | | | | | | | |
| ppm | | | | | | | |
| Content of | 1.5 | 1.5 | 1.5 | 1.5 | 1.5 | 1.5 | 1.5 |
| succinic acid, | | | | | | | |
| ppm | | | | | | | |
| Content of | 1.6 | 1.6 | 1.6 | 1.6 | 1.6 | 1.6 | 1.6 |
| alanine, ppm | | | | | | | |
| Content of | 0.5 | 0.5 | 0.5 | 0.5 | 0.5 | 0.5 | 0.5 |
| glycine, ppm | | | | | | | |
| Evaluation of | X | X | Δ | ⊚ | ⊚ | ◯ | X |
| rich taste | | | | | | | |

TABLE 2

| | Ref. | | | | | | Comp. |
|---|---|---|---|---|---|---|---|
| | Ex. 1 | Ex. 3 | Ex. 5 | Ex. 6 | Ex. 7 | Ex. 8 | Ex. 3 |
| Content of | 1.5 | 45 | 45 | 45 | 45 | 45 | 45 |
| glutamic acid, | | | | | | | |
| ppm | | | | | | | |
| Conten of | 1.5 | 1.5 | 8.8 | 12.4 | 16.1 | 23.4 | 30.5 |
| succinic acid, | | | | | | | |
| ppm | | | | | | | |
| Content of | 1.6 | 1.6 | 1.6 | 1.6 | 1.6 | 1.6 | 1.6 |
| alanine, ppm | | | | | | | |
| Content of | 0.5 | 0.5 | 0.5 | 0.5 | 0.5 | 0.5 | 0.5 |
| glycine, ppm | | | | | | | |
| Evaluation of | X | ⊚ | ⊚ | ⊚ | ⊚ | ◯ | ◯ |
| rich taste | | | | | | | |
| Evaluation of | | | | | | | |
| freeness of | | | | | | | |
| disagreeable | ⊚ | ⊚ | ⊚ | ◯ | ◯ | Δ | X |
| taste | | | | | | | |

TABLE 3

| | Ref. | | | | | | Comp. |
|---|---|---|---|---|---|---|---|
| | Ex. 1 | Ex. 3 | Ex. 9 | Ex. 10 | Ex. 11 | Ex. 12 | Ex. 4 |
| Content of | 1.5 | 45 | 45 | 45 | 45 | 45 | 45 |
| glutamic | | | | | | | |
| acid, ppm | | | | | | | |
| Content of | 1.5 | 1.5 | 15 | 1.5 | 1.5 | 1.5 | 15 |
| succinic acid, | | | | | | | |
| ppm | | | | | | | |
| Content of | 1.6 | 1.6 | 11.6 | 16.6 | 21.6 | 31.6 | 41.6 |
| alanine, ppm | | | | | | | |
| Content of | 0.5 | 0.5 | 0.5 | 0.5 | 0.5 | 0.5 | 0.5 |
| glycine, ppm | | | | | | | |
| Evaluation of | X | ⊚ | ⊚ | ⊚ | ⊚ | ◯ | ◯ |
| rich taste | | | | | | | |
| Evaluation of | ⊚ | ⊚ | ⊚ | ◯ | ◯ | Δ | X |
| freeness of | | | | | | | |
| disagreeable | | | | | | | |
| taste | | | | | | | |

TABLE 4

| | Ref. | | | | | Comp. | Comp. |
|---|---|---|---|---|---|---|---|
| | Ex. 1 | Ex. 3 | Ex. 13 | Ex. 14 | Ex. 15 | Ex. 5 | Ex. 6 |
| Content of | 1.5 | 45 | 45 | 45 | 45 | 45 | 45 |
| glutamic | | | | | | | |
| acid, ppm | | | | | | | |
| Content of | 1.5 | 1.5 | 1.5 | 1.5 | 1.5 | 1.5 | 1.5 |
| succinic | | | | | | | |
| acid, | | | | | | | |
| Content of | 1.6 | 1.6 | 1.6 | 1.6 | 1.6 | 1.6 | 1.6 |
| alanine, | | | | | | | |
| ppm | | | | | | | |
| Content of | 0.5 | 0.5 | 10.5 | 15.5 | 20.5 | 30.5 | 40.5 |
| glycine, | | | | | | | |
| ppm | | | | | | | |
| Evaluation | X | ⊚ | ⊚ | ⊚ | ⊚ | ◯ | ◯ |
| of rich | | | | | | | |
| taste | | | | | | | |
| Evaluation | ⊚ | ⊚ | ⊚ | ◯ | ◯ | X | X |
| of freeness | | | | | | | |
| of dis- | | | | | | | |
| agreeable | | | | | | | |
| taste | | | | | | | |

TABLE 5

| | Ref. | | | | | Comp. |
|---|---|---|---|---|---|---|
| | Ex. 1 | Ex. 3 | Ex. 16 | Ex. 17 | Ex. 18 | Ex. 7 |
| Content of | 1.5 | 45 | 45 | 45 | 45 | 45 |
| glutamic acid, | | | | | | |
| ppm | | | | | | |
| Content of | 1.5 | 1.5 | 8.8 | 12.4 | 16.1 | 23.4 |
| succinic acid, | | | | | | |
| Content of | 1.6 | 1.6 | 11.6 | 16.6 | 21.6 | 31.6 |
| alanine, ppm | | | | | | |
| Content of | 0.5 | 0.5 | 10.5 | 15.5 | 20.5 | 10.5 |
| glycine, ppm | | | | | | |
| Evaluation of | X | ⊚ | ⊚ | ⊚ | ⊚ | ◯ |
| rich taste | | | | | | |
| Evaluation of | ⊚ | ⊚ | ⊚ | Δ | Δ | X |
| freeness of | | | | | | |
| disagreeable | | | | | | |
| taste | | | | | | |

It could he seen from the results of Tables 1 to 5 that the nonalcoholic beer-taste beverages of each of Examples where the content of glutamic acid is from 27 to 90 ppm, and each of the contents of succinic acid, alanine, and glycine is equal to or less than a specified amount all have excellently rich taste. Here, a disagreeable taste by stimulation due to the increase in the content of succinic acid is found in Comparative Example 3, and the disagreeable tastes due to sweet taste are found due to the increase in the contents of alanine or glycine in Comparative Examples 4 to 7.

### INDUSTRIAL APPLICABILITY

According to the present invention, a beer-taste beverage with a new taste having an excellently rich taste can be provided.

1. A nonalcoholic beer-taste beverage wherein the content of glutamic acid is from 27 to 90 ppm, the content of succinic acid is 24 ppm or less, the content of alanine is 32 ppm or less, and the content of glycine is 24 ppm or less.

2. The nonalcoholic beer-taste beverage according to claim 1, wherein a total content of succinic acid, alanine, and glycine is 60 ppm or less.

3. A method for producing a nonalcoholic beer-taste beverage as defined in claim 1, comprising adding glutamic acid and/or a salt thereof.

4. A method of giving a rich taste to a nonalcoholic beer-taste beverage comprising adding glutamic acid and/or a salt thereof.

5. A method for producing a nonalcoholic beer-taste beverage as defined in claim 2, comprising adding glutamic acid and/or a salt thereof.
